(19) United States
(12) Patent Application Publication
(10) Pub. No.: US 2024/0137356 A1
(43) Pub. Date: Apr. 25, 2024

(54) SYSTEM-LEVEL AUTHENTICATION CREDENTIALS TO PERFORM DATA CENTER OPERATIONS

(71) Applicant: VMWARE, INC., Palo Alto, CA (US)

(72) Inventors: RAVI KUMAR REDDY KOTTAPALLI, Bangalore (IN); Sudarshana Kandachar Sridhara Rao, Bangalore (IN)

(21) Appl. No.: 17/969,693

(22) Filed: Oct. 19, 2022

(51) Int. Cl. H04L 9/40

(52) U.S. Cl. CPC H04L 63/0815; H04L 63/083

(57) ABSTRACT

An example method may include receiving a first authentication credential corresponding to a component in a data center. The first authentication credential may be provided by a user to access the component. Further, the method may include dynamically generating a second authentication credential corresponding to the first authentication credential. The second authentication credential may be system-generated to access the component. Furthermore, the method may include generating mapping information for mapping the second authentication credential to the first authentication credential. In response to receiving a first request to perform a data center operation that is dependent on the component, the method may include utilizing the first authentication credential to authenticate the first request and utilizing the second authentication credential to perform the data center operation using the mapping information.

### TECHNICAL FIELD

The present disclosure relates to computing environments, and more particularly to methods, techniques, and systems for generating system-level authentication credentials to perform data center operations in the computing environments.

### BACKGROUND

Data centers execute numerous applications that enable businesses, governments, and other organizations to offer services over the Internet. An example data center can be a hyper-converged infrastructure (HCl) solution. The HCl is a type of virtual computing platform that converges compute, networking, virtualization, and storage into a single software-defined architecture. For instance, a single software application can interact with each component of hardware and software as well as an underlying operating system. Hyper-converged infrastructures provide enterprises and other organizations with modular and expandable compute, storage, and network resources as well as system backup and recovery. In the hyper-converged infrastructure, compute, storage, and network resources are brought together using preconfigured and integrated hardware. In hyper-converged infrastructures, multiple physical hosts can be clustered together to create clusters and/or workload domains of shared compute and storage resources. Further, physical hosts in a host pool may be provisioned to the clusters based on a user request or resource utilization of the clusters, for instance. In such hyper-converged infrastructures, a centralized control may be provided to the components (e.g., the compute, networking, virtualization, and storage components) to perform different data center operations such as a data center security operation, a data center expansion operation, a data center deletion operation, a data center shrink operation, a data center update/upgrade operation, and the like.

### BRIEF DESCRIPTION OF THE DRAWINGS

FIG. 1 is a block diagram of an example computing environment, illustrating a management node to generate system-level authentication credentials to perform data center operations in a data center;

FIG. 2A is a block diagram of an example password management unit to generate a system-level password per component in a data center;

FIG. 2B is a block diagram of an example auto password module of FIG. 2A, depicting additional features;

FIG. 3A is a sequence diagram illustrating an example sequence of events to generate a system-level password for a component in a data center;

FIG. 3B depicts an example user-level to system-level password association table;

FIG. 4A is a sequence diagram illustrating an example sequence of events to modify a user-level password for a component in a data center;

FIG. 4B depicts the example user-level to system-level password association table of FIG. 3B, depicting an updated user-level password for the component;

FIG. 5 is a sequence diagram illustrating an example sequence of events to parallelly execute a data center operation and a trust change operation corresponding to a component of a data center;

FIG. 6 is a flow diagram illustrating an example computer-implemented method for generating system-level authentication credentials to perform data center operations; and

FIG. 7 is a block diagram of an example computing device including non-transitory computer-readable storage medium storing instructions to generate system-level authentication credentials to perform data center operations.

The drawings described herein are for illustrative purposes and are not intended to limit the scope of the present subject matter in any way.

### DETAILED DESCRIPTION

Examples described herein may provide an enhanced computer-based and/or network-based method, technique, and system to generate system-level authentication credentials to perform data center operations in a computing environment. The paragraphs to present an overview of the computing environment, existing methods for performing data center operations, and drawbacks associated with the existing methods.

Computing environment may be a physical computing environment (e.g., an on-premises enterprise computing environment or a physical data center) and/or a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. Example virtual computing environment may include different compute nodes (e.g., physical computers, virtual machines, and/or containers). Further, the computing environment may include multiple application hosts (i.e., physical computers) executing different workloads such as virtual machines, containers, and the like running therein. Each compute node may execute different types of applications and/or operating systems.

The data center can be an on-premises data center, a cloud data center, or a hybrid data center. For example, the data center can be a software-defined data center (SDDC) having a hyper-converged infrastructure solution. The term “hyper-converged infrastructure” may refer to a type of virtual computing platform that converges compute, networking, virtualization, and storage into a single software-defined architecture. The hyperconverged infrastructure may include virtualized computing (e.g., a hypervisor), a virtual storage area network (vSAN) (e.g., software-defined storage), and virtualized networking (e.g., software-defined networking). For example, Vmware® cloud foundation (VCF) is a hybrid cloud platform for managing virtual machines and orchestrating containers, built on a full stack hyperconverged infrastructure technology.

Such hyperconverged infrastructures may include multiple workload domains. The workload domains may include different combinations of servers (i.e., physical hosts) and network equipment which can be set up with varying levels of hardware redundancy and varying quality of components. A workload domain may represent a logical unit that groups physical hosts (e.g., enterprise-class, type-1 hypervisor (ESXi) servers) managed by a server instance (e.g., vCenter server) with specific characteristics according to software defined data center (SDDC) polices. Thus, the workload domain may include multiple clusters of physical hosts. The cluster may be a collection of resources (e.g., physical hosts) that collectively provide scalable services to end users and to their applications while maintaining a consistent, uniform, and single system view of the cluster services. Each node may be a single entity machine or server having compute, storage, and/or network capacity. Example cluster may be a stretched cluster, a multi-availability zone (AZ) cluster, a metro cluster, or a high availability (HA) cluster that crosses multiple areas within a local area network (LAN), a wide area network (WAN), or the like. By design, the cluster may provide a single point of control for cluster administrators and at the same time, the cluster may facilitate addition, removal, or replacement of individual resources without significantly affecting the services provided by the hyperconverged infrastructure.

Such cloud platforms may offer centralized control for deployed components (e.g., vCenter server (i.e., a centralized management utility to manage virtual machines), NSX-T (e.g., a unified networking platform to build cloud-native application environments), ESXI servers, and the like) in the hyperconverged infrastructure. For example, upon establishing or deploying the data center, data center operations may be carried over on the established data center. The centralized control is for performing the data center operations. Example data center operations may include data center security operations and data center on-demand operations (e.g., a data center expansion operation, a data center deletion operation, a data center shrink operation, a data center update/upgrade operation, a data center monitoring operation, and the like). Data center security operations may be performed for securing the data center operations like password management, certificate management, and the like. Data center on-demand operations may include data center workload or cluster creation, deletion, updating (e.g., expand, shrink, or the like), and the like based on customer demands.

Currently, data center security operations and data center on-demand operations are mutually exclusive and hence may cause an issue in handling the trust changes securely with zero-down time in the scaled hyper-converged infrastructure. Trust changes may refer to a password change, password update, or password rotate for the components (e.g., vCenters, NSX-T Managers, ESXI hosts, and the like) that are involved in the SDDC. Execution of one data center operation may be dependent on another data center operation. For example, during trust changes for the components in the SDDC, other critical data center operations such as the data center shrink operation, data center expansion operation, data center deletion operation, and the like may not be allowed. In this case, the user or an administrator may have to wait until the password is updated/changed to execute other data center operations. In this scenario, the waiting window may depend on a size of the components. Thus, the dependency of execution of the data center operations may cause inconvenience to the users of the data center, thereby affecting the user experience.

Examples described herein may provide a management node to generate system-level authentication credentials to perform data center operations. The system-level authentication credentials may enable the data center operations to be executed independently and in parallel to password changing operations with zero-down time of the data center. In an example, the management node may receive a first authentication credential corresponding to a component in the data center. The first authentication credential is provided by a user to access the component. Further, the management node may dynamically generate a second authentication credential corresponding to the first authentication credential. The second authentication credential is system-generated to access the component. Further, the management node may generate mapping information for mapping the second authentication credential to the first authentication credential. In response to receiving a request to perform a data center operation that is dependent on the component, the management node may utilize the first authentication credential to authenticate the request and utilize the second authentication credential to perform the data center operation using the mapping information.

Examples described herein provide system-level authentication credentials to perform data center operations in parallel with processing a change in user-level authentication credentials (i.e., the password). Thus, the user-level authentication credentials can be changed in parallel with the execution of the data center operations with zero downtime. Further, examples described herein may enhance manageability and availability of the data center operations to the users and also improves the security of the data centers by reducing the security risks.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

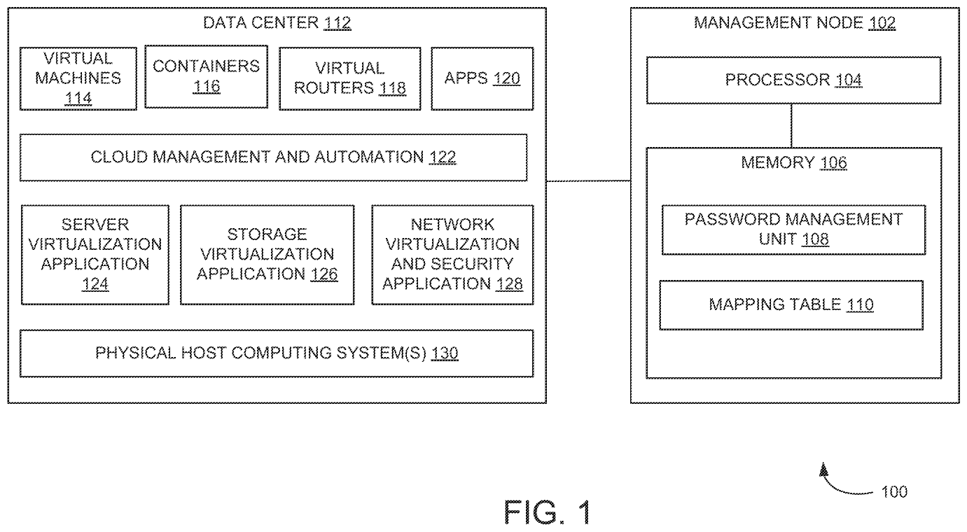

FIG. 1 is a block diagram of an example computing environment 100, illustrating a management node 102 to generate system-level authentication credentials to perform data center operations in a data center 112. Cloud computing environment 100 may be based on the deployment of physical resources across a network, virtualizing the physical resources into virtual resources, and provisioning the virtual resources in data center 112 for use across cloud computing services and applications. Data center 112 may refer to a centralized physical facility where servers, network, storage, and other information technology equipment that support business operations exist. The computers in a data center include or facilitate business-critical applications, services, data, and the like.

For example, data center 112 may be a software-defined data center (SDDC) with hyperconverged infrastructure (HCl). In SDDC with hyper-converged infrastructure, networking, storage, processing, and security may be virtualized and delivered as a service. The hyper-converged infrastructure may combine a virtualization platform such as a hypervisor, virtualized software-defined storage, and virtualized networking in the data center deployment. For example, data center 112 may include different components such as a server virtualization application 124 (e.g., vSphere of VMware®), a storage virtualization application 126 (e.g., vSAN of VMware®), a network virtualization and security application 128 (e.g., NSX of VMware®), physical host computing systems 130 (e.g., ESXi servers), or any combination thereof. Further, data center 112 may include a cloud management and automation platform 122 to deploy different components and manage different workloads such as virtual machines 114, containers 116, virtual routers 118, applications 120, and the like. An example platform to deploy and manage data center 112 may include VMware Cloud Foundation™ (VCF), which is commercially available from VMware. VCF may be a hybrid cloud platform that provides a full stack hyperconverged infrastructure that is made for modernizing data centers and deploying modern container-based applications. VCF integrates different components like vSphere (compute), vSAN (storage), NSX (networking) and some parts of the vRealize Suite in a hyper-converged infrastructure solution with infrastructure automation and software lifecycle management. The idea of VCF follows a standardized, automated, and validated approach that simplifies the management of the needed software-defined infrastructure resources. So, VCF is fully integrated software composed of (vSphere, NSX, vSAN, and SDDC Manager) based on the concepts of Hyper-Converged Infrastructure or HCl, which accelerates the delivery of virtual infrastructure (VI) or virtual desktop infrastructure (VDI).

Data center operations refer to the workflow and processes that are performed within data center 112 to keep data center 112 running. Data center operations include computing and non-computing processes that are specific to a data center facility or data center environment. Data center operations include automated and manual processes essential to keep the data center operational. Example data center operations include installing and maintaining network resources, ensuring data center security and monitoring systems that take care of power and cooling.

As shown in FIG. 1, data center 112 may be communicatively connected to management node 102 via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Management node 102 may include a processor 104. Processor 104 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein. Further, management node 102 includes memory 106 coupled to processor 104. Memory 106 includes a password management unit 108.

During operation, password management unit 108 may receive a first authentication credential corresponding to a component (e.g., server virtualization application 124, storage virtualization application 126, network virtualization and security application 128, cloud management and automation platform 122, physical host computing system 130, or any combination thereof) in data center 112. The first authentication credential may be user-defined to access the component (i.e., to login to the user account associated with the component). Further, the first authentication credential may include a variable password that can be changed by the user. For example, the first authentication credential may be digital documents that associate the user's identity to some form of proof of authenticity, such as a certificate, a password, a personal identification number (PIN), or the like.

Further, password management unit 108 may generate a second authentication credential corresponding to the first authentication credential. The second authentication credential may be system-generated to perform a data center operation related to the component. Further, the second authentication credential may include a static password that is not exposed to the user. An example data center operation may include a data center expansion operation (e.g., add a host computing system to a cluster), a data center deletion operation (e.g., delete a cluster), a data center shrink operation (e.g., delete a host computing system from a cluster), a data center update/upgrade operation (e.g., update/upgrade resources/applications in a cluster), a data center monitoring operation (e.g., monitor a cluster, a workload, or the like), a data center management operation (e.g., manage and monitor the components), a data center creation operation (e.g., add a cluster), a data center security operation, or any combination thereof.

Furthermore, password management unit 108 may generate a mapping table 110 for mapping the second authentication credential to the first authentication credential. In an example, password management unit 108 may generate a first identifier corresponding to the first authentication credential, generate a second identifier corresponding to the second authentication credential, and generate the mapping information for mapping the first authentication credential to the second authentication credential using the first identifier and the second identifier.

In an example, in response to receiving a first request to update the first authentication credential corresponding to the component, password management unit 108 may update the first authentication credential corresponding to the component in mapping table 110 while the second authentication credential is utilized to perform the data center operation related to the component.

In another example, in response to receiving a second request to perform the data center operation that is dependent on the component, password management unit 108 may utilize the first authentication credential to authenticate the second request. Further, password management unit 108 may retrieve the second authentication credential corresponding to the first authentication credential using the mapping information upon authenticating the second request. Furthermore, password management unit 108 may utilize the second authentication credential to perform the data center operation while the first authentication credential corresponding to the component is being updated.

Examples described herein may manage trust changes in parallel with other data center operations in the SDDCs with zero downtime, thereby enhancing the manageability and availability of the data center operations to the customers. Further, examples described herein may provide a scalable and secure approach in handling the trust changes with zero downtime. Further, the 2-level password (i.e., user-defined and system-generated passwords) may improve the security of the SDDCs and reduce security risks. Further, examples described herein may utilize the existing infrastructure and may not need any additional protocols or external components. Furthermore, examples described herein may be implemented in any platform where the platform demands zero down time during the trust changes (i.e., authentication credential or password changes).

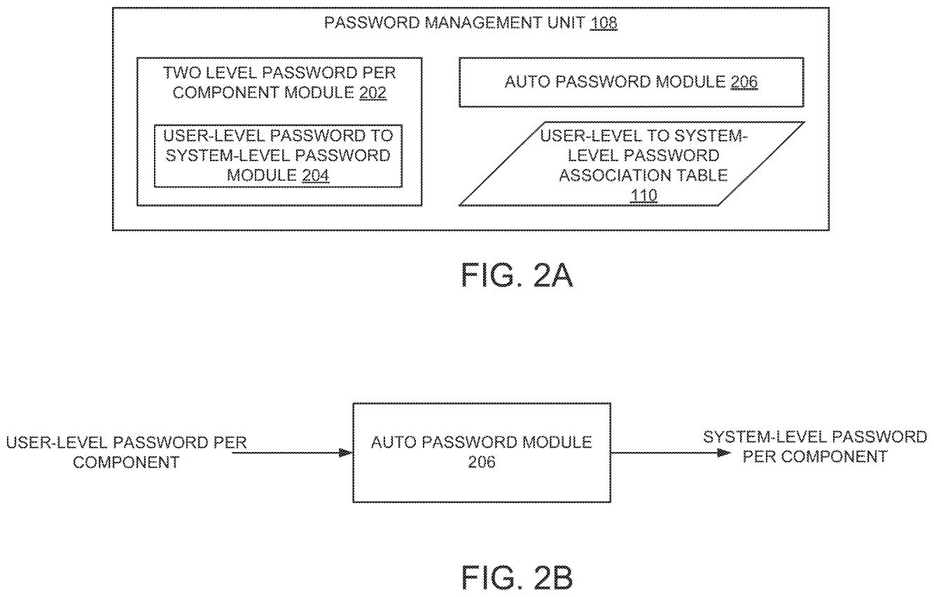

FIG. 2A is a block diagram of an example password management unit (e.g., password management unit 108 of FIG. 1) to generate a system-level password (i.e., system-level authentication credential) per component in a data center. For example, similarly named elements of FIG. 2A may be similar in structure and/or function to elements described with respect to FIG. 1. As shown in FIG. 2A, password management unit 108 includes a two-level password per component (2LPC) module 202 and an auto password module 206. Further, 2LPC module 202 includes a user-level password to system-level password (ULP2SLP) module 204.

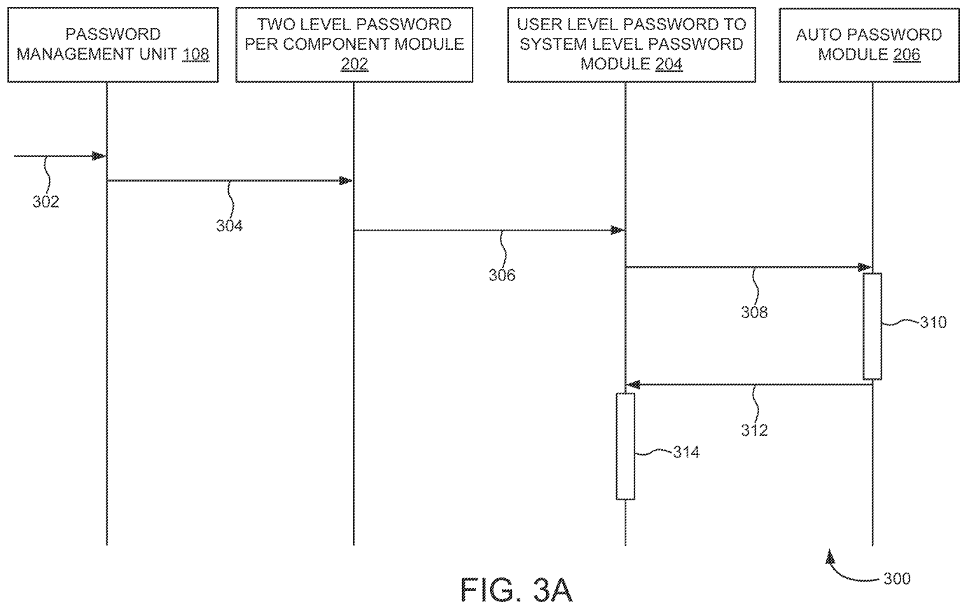

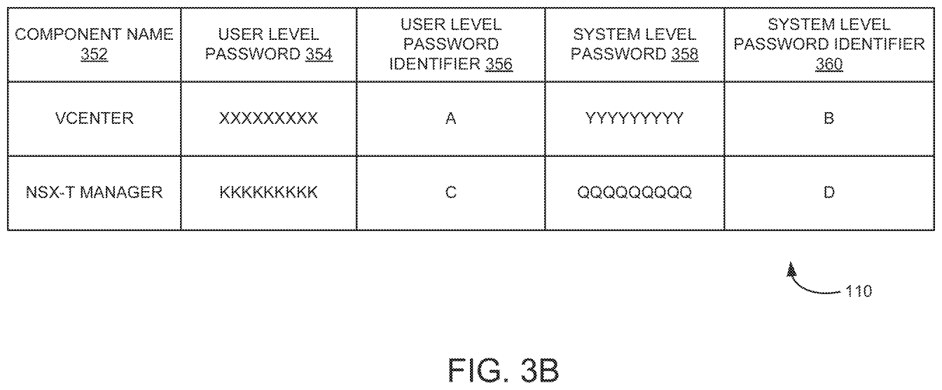

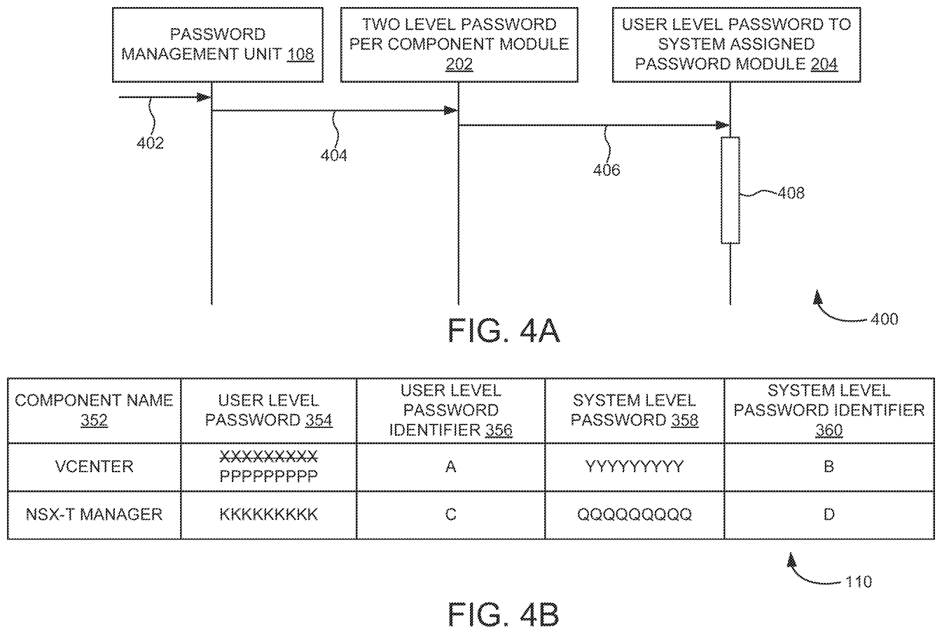

In an example, 2LPC module 202 may maintain two levels of passwords for each component in the data center. An example two levels of passwords are a user-level password (e.g., authentication credential given by a user) and a system-level password (e.g., authentication credential given by auto password module 206). The user-level password includes a variable password defined by a user. The system-level password includes a static password generated by 2LPC module 202. For example, ULP2SLP module 204 of 2LPC module 202 generates the system-level password for every user-level password of the component using auto password module 206. In this example, auto password module 206 may generate a system-level password for each user given password for each component in the data center. An example generation of the system-level password is described in FIG. 2B. Further, ULP2SLP module 204 may generate unique identifiers for each system-level password and the corresponding user-level password. Further, 2LPC module 202 may store the system-level password and its corresponding user-level password, along with corresponding identifiers in a user-level to system-level password association table 110 (i.e., mapping table 110 of FIG. 1). User-level to system-level password association table 110 may be a dynamic association table generated and maintained by 2LPC module 202. User-level to system-level password association table 110 may maintain an association/mapping between the user-level to system-level passwords. An example user-level to system-level password association table 110 is depicted in FIGS. 3B and 4B.

FIG. 2B is a block diagram of example auto password module 206 of FIG. 2A, depicting additional features. For example, similarly named elements of FIG. 2B may be similar in structure and/or function to elements described with respect to FIG. 2A. For example, auto password module 206 may receive a user-level password for a component from the user. Further, auto password module 206 generates a corresponding system-level password for the component. In an example, the user-level password and the system-level password for the component may be intact.

In some examples, the user-level password can be changed by the user based on his/her requirements. However, the system-level password cannot be changed and the system-level password for the component may be maintained constant. During execution of a data center operation, for example, when the user initiates a data center expansion operation, a data center deletion operation, a data center shrink operation, a data center update/upgrade operation, or the like, a system-level password corresponding to the user-level password may be used internally to execute the data center operation, which is described in FIG. 3A.

In some examples, the functionalities described in FIGS. 1, 2A, and 2B, in relation to instructions to implement functions of password management unit 108, 2LPC module 202, ULP2SLP module 204, auto password module 206, and any additional instructions described herein in relation to the storage medium, may be implemented as engines or modules including any combination of hardware and programming to implement the functionalities of the modules or engines described herein. The functions of password management unit 108, 2LPC module 202, ULP2SLP module 204, and auto password module 206 may also be implemented by a processor. In examples described herein, the processor may include, for example, one processor or multiple processors included in a single device or distributed across multiple devices.

FIG. 3A is a sequence diagram 300 illustrating an example sequence of events to generate a system-level password for a component in a data center. The data center (e.g., data center 112 of FIG. 1) may include a hyper-converged infrastructure (HCl) solution. For example, similarly named elements of FIG. 3A may be similar in structure and/or function to elements described with respect to FIG. 2A. Sequence diagram 300 may represent the interactions and the operations involved in generating the system-level password for the component. FIG. 3A illustrates process objects including password management unit 108, 2LPC module 202, ULP2SLP module 204, and auto password module 206 along with their respective vertical lines originating from them. The vertical lines of password management unit 108, 2LPC module 202, ULP2SLP module 204, and auto password module 206 may represent the processes that may exist simultaneously. The horizontal arrows (e.g., 302, 304, 306, 308, and 312) may represent the data flow steps between the vertical lines originating from their respective process objects (for e.g., password management unit 108, 2LPC module 202, ULP2SLP module 204, and auto password module 206). Further, activation boxes (e.g., 310 and 314) between the horizontal arrows may represent the process that is being performed in the respective process object.

At 302, a user provides a user-level password for the component (e.g., vCenter, NSX-T manager, an ESXI host, or the like) to password management unit 108. At 304, password management unit 108 may request 2LPC module 202 to generate the system-level password for the corresponding user-level password of the component. At 306, 2LPC module 202 forwards the request to generate the system-level password to ULP2SLP module 204. Upon receiving the request, ULP2SLP module 204 instructs auto password module 206 to generate the system-level password, at 308. At 310, auto password module 206 generates the requested unique system-level password. Further, auto password module 206 returns the generated system-level password to ULP2SLP module 204, at 312. In an example, ULP2SLP module 204 may generate unique identifiers for each user-level password and corresponding system-level password of the component. Further, at 314, ULP2SLP module 204 may populate a table called user-level to system-level password association table (or mapping table 110 of FIG. 1) and associates the user-level password to the system-level password for the component using the unique identifiers. An example table is depicted in FIG. 3B.

FIG. 3B depicts an example user-level to system-level password association table (e.g., mapping table 110 of FIG. 1 and FIG. 2A). In an example, user-level to system-level password association table 110 of FIG. 3B may be generated by ULP2SLP module 204 of FIG. 3A. User-level to system-level password association table 110 may include a plurality of columns representing a component name 352, a user-level password 354 for the component, a unique identifier 356 for the user-level password 354, a system-level password 358 for the user-level password 354, and a unique identifier 360 for the system-level password 358. In an example, ULP2SLP module 204 may maintain user-level to system-level password association table 110. In this example, system-level password 358 for the component may not be exposed to the user or administrators and system-level password 358 may be handled only by the components.

FIG. 4A is a sequence diagram 400 illustrating an example sequence of events to modify a user-level password for a component in a data center. For example, similarly named elements of FIG. 4A may be similar in structure and/or function to elements described with respect to FIG. 2A. Sequence diagram 400 may represent the interactions and the operations involved in modifying the user-level password for the component. FIG. 4A illustrates process objects including password management unit 108, 2LPC module 202, and ULP2SLP module 204 along with their respective vertical lines originating from them. The vertical lines of password management unit 108, 2LPC module 202, and ULP2SLP module 204 may represent the processes that may exist simultaneously. The horizontal arrows (e.g., 402, 404, and 406) may represent the data flow steps between the vertical lines originating from their respective process objects (for e.g., password management unit 108, 2LPC module 202, and ULP2SLP module 204). Further, activation boxes (e.g., 408) between the horizontal arrows may represent the process that is being performed in the respective process object.

A user selects a component and requests for a password update for the component. At 402, password management unit 108 receives the request for the password update for the component from the user. At 404, password management unit 108 identifies the action of user as the password update request for the component and forwards the request to 2LPC module 202. At 406, 2LPC module 202 forwards the request to generate the system-level password to ULP2SLP module 204. At 408, ULP2SLP module 204 may update the user-level password in the user-level to system-level password association table for the component, as depicted in example FIG. 4B.

FIG. 4B depicts example user-level to system-level password association table 110 of FIG. 3B, depicting an updated user-level password for the component. For example, user-level to system-level password association table 110 of FIG. 3B may be generated by ULP2SLP module 204 of FIG. 4A. As shown in system-level password association table 110 of FIG. 4B, user-level password 354 for component name 352 ‘vCenter’ is modified (i.e., user-level password “XXXXXXXXX” for component “vCenter” is updated to “PPPPPPPPP”). In the example shown in FIG. 4B, the modified user-level password 354 is mapped to existing system-level password 358. Thus, user-level password 354 includes a variable password that can be changed by the user and system-level password 358 includes a static password that is not exposed to the user. Thus, ULP2SLP module 204 may consult user-level to system-level password association table 110 of FIG. 3B and only changes the user-level level password for the component. ULP2SLP module 204 may not modify the system-level password. Thus, examples described herein may manage the trust (i.e., password) changes securely with zero-down time in the data center.

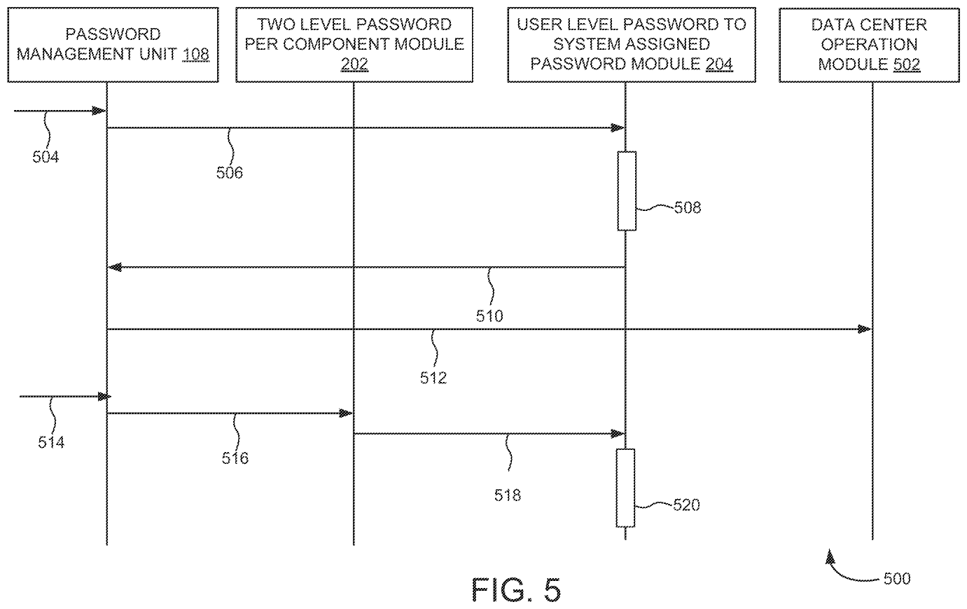

FIG. 5 is a sequence diagram 500 illustrating an example sequence of events to parallelly execute a data center operation and a trust change operation corresponding to a component (e.g., a host computing system) of a data center. For example, similarly named elements of FIG. 5 may be similar in structure and/or function to elements described with respect to FIG. 2A. Sequence diagram 500 may represent the interactions and the operations involved in generating the system-level password for the host computing system. FIG. 5 illustrates process objects including password management unit 108, 2LPC module 202, ULP2SLP module 204, and a data center operation module 502 along with their respective vertical lines originating from them. The vertical lines of password management unit 108, 2LPC module 202, ULP2SLP module 204, and data center operation module 502 may represent the processes that may exist simultaneously. The horizontal arrows (e.g., 504, 506, 510, 512, 514, 516, and 518) may represent the data flow steps between the vertical lines originating from their respective process objects (for e.g., password management unit 108, 2LPC module 202, ULP2SLP module 204, and data center operation module 502). Further, activation boxes (e.g., 508 and 520) between the horizontal arrows may represent the process that is being performed in the respective process object.

Consider that the user initiates a data center operation (e.g., a data center expansion operation) and then a password update operation for the host computing system that is involved in the data center expansion operation. At 504, the user may request the data center expansion operation (e.g., to “add a host to a cluster”). At 506, password management unit 108 may intercept the request and forward the request to ULP2SLP module 204 to provide the system-level password for the host computing system that involved for the data center expansion operation. At 508, ULP2SLP module 204 consults the user-level to system-level password association table to retrieve a corresponding system-level password and return the corresponding system-level password of the host computing system to the password management unit 108, at 510. At 512, password management unit 108 then returns the system-level password to data center operation module 502 to perform the data center expansion operation. Thus, data center operation module 502 performs data center operations using the system-level password of the host computing system.

Consider that the user initiates the password update for the host computing system that was involved in the data center expansion operations (i.e., during execution of the data center expansion operations). During the execution of the data center expansion operations, the user requests a password update for the host computing system involved in the data center expansion operation, at 514. At 516, password management unit 108 may intercept the request and forward the request to 2LPC module 202 for the password update of the host computing system. At 518, 2LPC module 202 forwards the request for password update to ULP2SLP module 204. At 520, ULP2SLP module 204 consults the user-level to system-level password association table and change the user-level password for the host computing system in the user-level to system-level password association table. However, ULP2SLP module 204 may not modify the system-level password and the intact mapping between the system-level and the user-level passwords in the user-level to system-level password association table.

The sequence steps 504 to 512 to perform the data center operation can be performed in parallel with the sequence steps 514 to 520 to update the password for the component that is involved in the datacentre expansion operations. Thus, sequence diagram 500 represents the parallel operations initiated by the user and handle both the operations (i.e., the password update operation and the data center expansion operation) in parallel and independently. Both the operations may be independent to each other hence there is no down-time in the data center. Further, the user-level passwords may be exposed to the users, or the administrators and the system-level passwords are not exposed. Thus, examples described herein may provide another layer of security for the components in the data center.

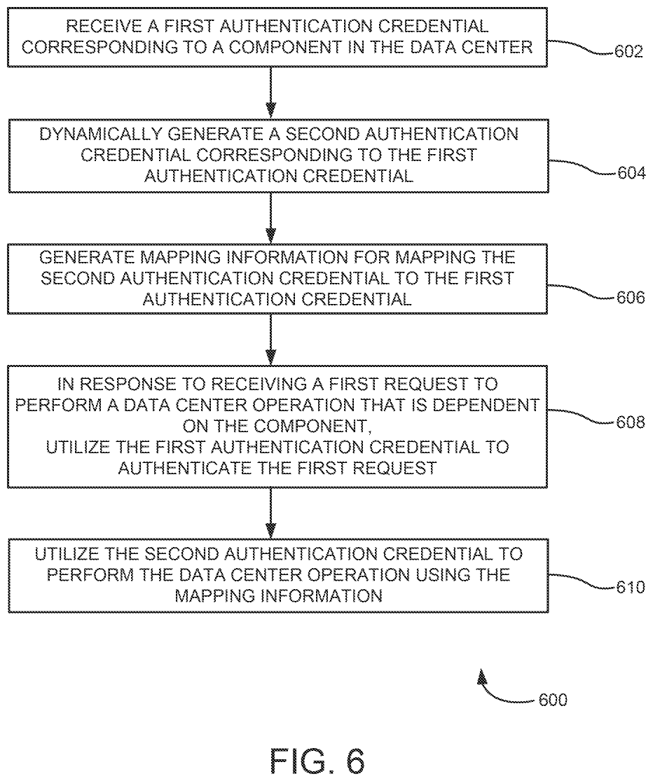

FIG. 6 is a flow diagram illustrating an example computer-implemented method 600 for generating system-level authentication credentials to perform data center operations. Example method 600 depicted in FIG. 6 represents generalized illustrations, and other processes may be added, or existing processes may be removed, modified, or rearranged without departing from the scope and spirit of the present application. In addition, method 600 may represent instructions stored on a computer-readable storage medium that, when executed, may cause a processor to respond, to perform actions, to change states, and/or to make decisions. Alternatively, method 600 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 602, a first authentication credential corresponding to a component in a data center may be received. The first authentication credential may be provided by a user to access the component. For example, the first authentication credential includes a variable password that can be changed by the user. In an example, the data center may be a software-defined data center (SDDC) having a hyper-converged infrastructure (HCl) solution based on defined hardware configurations which are pre-integrated with SDDC software. Further, the component may include a server virtualization application, a storage virtualization application, a network virtualization and security application, a cloud management application, a physical host computing system, or any combination thereof.

At 604, a second authentication credential corresponding to the first authentication credential may be dynamically generated. The second authentication credential may be system-generated to access the component. For example, the second authentication credential may include a static password that is not exposed to the user.

At 606, mapping information for mapping the second authentication credential to the first authentication credential may be generated. In an example, generating the mapping information may include generating a first identifier corresponding to the first authentication credential and a second identifier corresponding to the second authentication credential. Further, the mapping information for mapping the first authentication credential to the second authentication credential using the first identifier and the second identifier may be generated.

At 608, in response to receiving a first request to perform a data center operation that is dependent on the component, the first authentication credential may be utilized to authenticate the first request. At 610, the second authentication credential may be utilized to perform the data center operation using the mapping information. In an example, the data center operation may include a data center expansion operation, a data center deletion operation, a data center shrink operation, a data center update/upgrade operation, a data center monitoring operation, a data center management operation, a data center creation operation, a data center security operation, or any combination thereof.

Further, method 600 may include receiving a second request to update the first authentication credential corresponding to the component. Upon receiving the second request, the first authentication credential may be updated in accordance with the second request. Further, the mapping information for mapping the updated first authentication credential to the second authentication credential may be updated.

In this example, utilizing the second authentication credential to perform the data center operation may include retrieving the second authentication credential corresponding to the first authentication credential using the mapping information. Further, the data center operation may be performed using the retrieved second authentication credential in parallel with updating the first authentication credential in accordance with the second request.

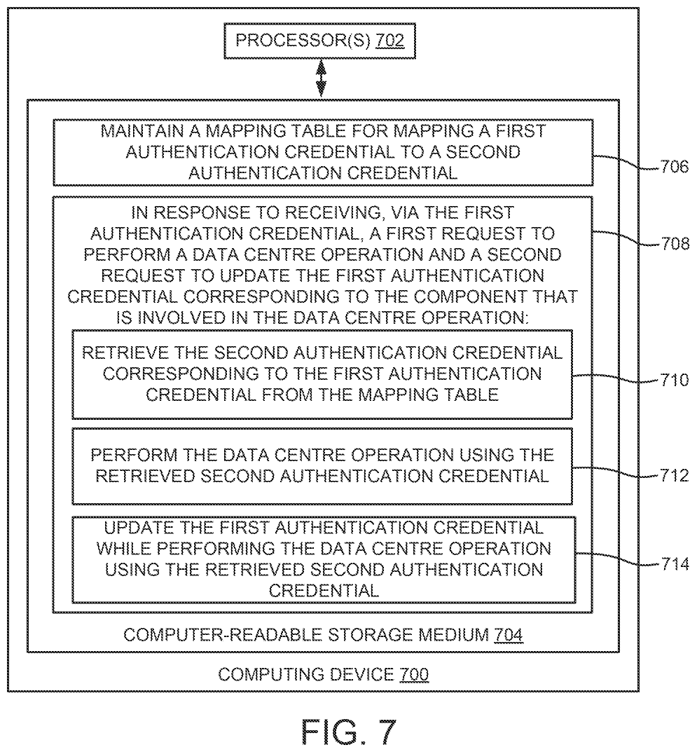

FIG. 7 is a block diagram of an example computing device 700 including non-transitory computer-readable storage medium 704 storing instructions to generate system-level authentication credentials to perform data center operations. Computing device 700 may include a processor 702 and computer-readable storage medium 704 communicatively coupled through a system bus. Processor 702 may be any type of central processing unit (CPU), microprocessor, or processing logic that interprets and executes computer-readable instructions stored in computer-readable storage medium 704. Computer-readable storage medium 704 may be a random-access memory (RAM) or another type of dynamic storage device that may store information and computer-readable instructions that may be executed by processor 702. For example, computer-readable storage medium 704 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 704 may be a non-transitory computer-readable medium. In an example, computer-readable storage medium 704 may be remote but accessible to computing device 700.

Computer-readable storage medium 704 may store instructions 706, 708, 710, 712, and 714. Instructions 706 may be executed by processor 702 to maintain a mapping table for mapping a first authentication credential to a second authentication credential. In an example, the first authentication credential may be provided by a user to access a component in a data center and the second authentication credential may be system-defined to access the component. For example, the first authentication credential may include a variable password that can be changed by the user and the second authentication credential may include a static password that is not exposed to the user.

Further, instructions 708 may be executed by processor 702 to receive, via the first authentication credential, a first request to perform a data center operation and a second request to update the first authentication credential corresponding to the component that is involved in the data center operation. Upon receiving the first request, instructions 710 may be executed by processor 702 to retrieve the second authentication credential corresponding to the first authentication credential from the mapping table. In an example, instructions 710 to retrieve the second authentication credential corresponding to the first authentication credential may include instructions to authenticate the first request using the first authentication credential and retrieve the second authentication credential corresponding to the first authentication credential upon authenticating the first request.

Further, instructions 712 may be executed by processor 702 to perform the data center operation using the retrieved second authentication credential. Furthermore, instructions 714 may be executed by processor 702 to update the first authentication credential while performing the data center operation using the retrieved second authentication credential. Further, computer-readable storage medium 704 may store instructions to update the mapping table for mapping the updated first authentication credential to the second authentication credential.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
receiving a first authentication credential corresponding to a component in a data center, wherein the first authentication credential is provided by a user to access the component;
dynamically generating a second authentication credential corresponding to the first authentication credential, wherein the second authentication credential is system-generated to access the component;
generating mapping information for mapping the second authentication credential to the first authentication credential; and
in response to receiving a first request to perform a data center operation that is dependent on the component,
utilizing the first authentication credential to authenticate the first request; and
utilizing the second authentication credential to perform the data center operation using the mapping information.

2. The method of claim 1, further comprising:
receiving a second request to update the first authentication credential corresponding to the component;
updating the first authentication credential in accordance with the second request; and
updating the mapping information for mapping the updated first authentication credential to the second authentication credential.

3. The method of claim 2, wherein utilizing the second authentication credential to perform the data center operation comprises:
retrieving the second authentication credential corresponding to the first authentication credential using the mapping information; and
performing the data center operation using the retrieved second authentication credential in parallel with updating the first authentication credential in accordance with the second request.

4. The method of claim 1, wherein generating the mapping information comprises:
generating a first identifier corresponding to the first authentication credential;
generating a second identifier corresponding to the second authentication credential; and
generating the mapping information for mapping the first authentication credential to the second authentication credential using the first identifier and the second identifier.

5. The method of claim 1, wherein the component comprises a server virtualization application, a storage virtualization application, a network virtualization and security application, a cloud management application, a physical host computing system, or any combination thereof.

6. The method of claim 1, wherein the first authentication credential includes a variable password that can be changed by the user.

7. The method of claim 1, wherein the second authentication credential includes a static password that is not exposed to the user.

8. The method of claim 1, wherein the data center operation comprises a data center expansion operation, a data center deletion operation, a data center shrink operation, a data center update/upgrade operation, a data center monitoring operation, a data center management operation, a data center creation operation, a data center security operation, or any combination thereof.

9. The method of claim 1, wherein the data center is a software-defined data center (SDDC) having a hyper-converged infrastructure (HCl) solution based on defined hardware configurations which are pre-integrated with SDDC software.

10. A management node comprising:
a processor; and
memory coupled to the processor, wherein the memory comprises a password management unit to:
receive a first authentication credential corresponding to a component in a data center, wherein the first authentication credential is user-defined to access the component;
generate a second authentication credential corresponding to the first authentication credential, wherein the second authentication credential is system-generated to perform a data center operation related to the component;
generate a mapping table for mapping the second authentication credential to the first authentication credential; and
in response to receiving a first request to update the first authentication credential corresponding to the component:
update the first authentication credential corresponding to the component in the mapping table while the second authentication credential is utilized to perform the data center operation related to the component.

11. The management node of claim 10, wherein the password management unit is to:
in response to receiving a second request to perform the data center operation that is dependent on the component,
utilize the first authentication credential to authenticate the second request;
retrieve the second authentication credential corresponding to the first authentication credential using the mapping information upon authenticating the second request; and
utilize the second authentication credential to perform the data center operation while the first authentication credential corresponding to the component is being updated.

12. The management node of claim 10, wherein the password management unit is to:
generate a first identifier corresponding to the first authentication credential;
generate a second identifier corresponding to the second authentication credential; and
generate the mapping information for mapping the first authentication credential to the second authentication credential using the first identifier and the second identifier.

13. The management node of claim 10, wherein the component comprises a server virtualization application, a storage virtualization application, a network virtualization and security application, a cloud management application, a physical host computing system, or any combination thereof.

14. The management node of claim 10, wherein the first authentication credential includes a variable password that can be changed by a user.

15. The management node of claim 10, wherein the second authentication credential includes a static password that is not exposed to a user.

16. The management node of claim 10, wherein the data center comprises a hyper-converged infrastructure (HCl) solution.

17. A non-transitory computer-readable storage medium storing instructions that, when executed by a processor of a computing device, cause the processor to:
maintain a mapping table for mapping a first authentication credential to a second authentication credential, wherein the first authentication credential is provided by a user to access a component in a data center and the second authentication credential is system-defined to access the component; and
in response to receiving, via the first authentication credential, a first request to perform a data center operation and a second request to update the first authentication credential corresponding to the component that is involved in the data center operation,
retrieve the second authentication credential corresponding to the first authentication credential from the mapping table;
perform the data center operation using the retrieved second authentication credential; and
update the first authentication credential while performing the data center operation using the retrieved second authentication credential.

18. The non-transitory computer-readable storage medium of claim 17, further comprising instructions to:
update the mapping table for mapping the updated first authentication credential to the second authentication credential.

19. The non-transitory computer-readable storage medium of claim 17, wherein instructions to retrieve the second authentication credential corresponding to the first authentication credential comprises instructions to:
authenticate the first request using the first authentication credential; and
retrieve the second authentication credential corresponding to the first authentication credential upon authenticating the first request.

20. The non-transitory computer-readable storage medium of claim 17, wherein the first authentication credential includes a variable password that can be changed by the user and wherein the second authentication credential includes a static password that is not exposed to the user.
